(19) United States
(12) Patent Application Publication
(10) Pub. No.: US 2009/0147386 A1
(43) Pub. Date: Jun. 11, 2009

(54) Temperature-regulating devices for reflective optical elements

(75) Inventors: Michael R. Sogard, Menlo Park, CA (US); Douglas C. Watson, Campbell, CA (US)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 12/001,529

(22) Filed: Dec. 11, 2007

(51) Int. Cl. G02B 7/195

(52) U.S. Cl. 359/845

(57) ABSTRACT

Thermal-transfer devices (e.g., cooling devices) are disclosed for optical elements. An exemplary device includes a thermally conductive substrate having a surface. At least one mounting element extends from the surface to a reverse face of the optical element. The mounting element positions the optical element relative to the substrate with a gap between the surface and the reverse face. At least one gas-introduction port is situated relative to the gap. Also included is a gaseous thermal-conduction pathway across the gap between the optical element and the substrate. The thermal-conduction pathway includes flowing gas introduced (e.g., as a thin layer) into the gap by the gas-introduction port.

### FIELD

This disclosure pertains to reflective optical elements such as mirrors. More specifically, the disclosure pertains to cooling or otherwise regulating the temperature of reflective optical elements that, for example, experience heating when irradiated or undergo a temperature change during use.

### BACKGROUND

In various types of optical systems, the constituent optical elements such as lenses, filters, and/or mirrors are impinged with the radiation with which the system is used. If an optical element absorbs some of the incident radiation and especially if the incident radiation is intense, the element likely will experience a significant increase in temperature. Such a temperature change can thermally distort an optical element, for example the reflective surface of a mirror. With many types of optical systems, the intensity of radiation is normally too low to cause significant heating of the elements, the system can continue to function satisfactorily despite being heated, or any thermal-distortion effects of heating can be accommodated without any significant degradation of system performance. But, in other optical systems, especially systems used for extremely demanding imaging and the like, thermal distortion of one or more optical elements can degrade the system's overall optical performance to below specifications.

Certain types of optical systems are designed and constructed to such extremely tight dimensional and geometrical tolerances that serious attention must be directed to avoiding excessive heating of the constituent optical elements. Examples of such systems are astronomical telescopes, many types of space-borne optical systems, high-power laser systems, and microlithography systems. Indeed, many types of optical systems that normally operate in a vacuum probably could benefit from such attention.

Most current microlithography systems use wavelengths of deep ultraviolet (DUV) light (λ=150 to 250 nm) for imaging purposes. To achieve further improvement of imaging resolution, substantial research is being directed to the development of practical microlithography systems that use “extreme ultraviolet” (EUV) wavelengths, in the range of 11 to 14 nm. Whereas optical systems (such as projection-optical systems) for use with DUV light are mostly to fully refractive, no materials are currently known that are sufficiently transmissive to EUV light and that exhibit a usable refractive index to EUV light for use in making EUV lenses. Consequently, current EUV optical systems are entirely reflective and typically comprise multiple mirrors each having a multilayer EUV-reflective coating on its reflective surface to provide the mirror with a usable reflectivity (approximately 70%, maximum) to EUV light at non-grazing angles of incidence.

An EUV-reflective mirror often experiences heating during use because its multilayer reflective coating absorbs a substantial amount (with current mirrors, a minimum of approximately 30%) of the incident EUV radiation, and the EUV radiation on the mirror is usually intense. Similarly, a mirror used in a high-power laser system, even a mirror exhibiting very high reflectivity to the incident light, typically experiences significant heating during use. In such situations it is desirable to remove heat from the mirror. One conventional method of removing heat is simply allowing the heat to radiate from the mirror. This method is inefficient and may not provide a sufficient rate of cooling. Another conventional method of conducting heat from the mirror is by mounting the mirror to a substrate or base using thermally conductive mirror mounts. This method also is inefficient and may be impractical if the mirror mounts are also configured, for example, for attenuating transmission of vibrations to the mirror. Also, whereas regions of the mirror situated near the mirror mounts may receive adequate cooling, in-board regions of the mirror may not be adequately cooled, resulting in an undesirable temperature gradient across the mirror.

Yet another conventional method of conducting heat from the mirror is mounting the mirror directly to a thermally conductive substrate or base. Whereas this method offers mechanical rigidity, good thermal conductivity, and convenience, the substrate is usually made of a different material than the mirror. If the mirror and substrate are connected together intimately for optimal thermal conduction, any temperature change in the substrate will impart thermal stresses to the mirror that can warp the mirror.

Because of the extreme demands placed on the performance of EUV optical systems, mirrors of such a system are made mostly of a material, such as ZERODUR® (Schott, Germany), that exhibits a very low coefficient of thermal expansion and thus provides the mirrors with high thermal and mechanical stability. The low-thermal-expansion material is initially formed as a “mirror blank” of which a surface is figured and coated to form a reflective surface for reflecting incident EUV radiation in the desired manner. The mirror blanks are conventionally mounted directly to thermally conductive substrates. To prevent significant temperature gradients from forming in the substrate, the substrate can be liquid-cooled. Unfortunately, the metal substrate usually has a coefficient of thermal expansion that is not well matched to ZERODUR. Thus, again, temperature changes in the substrate or mirror will cause thermal stresses that can warp or otherwise deform the mirror.

Therefore, a need exists for improved cooling devices for mirrors and other reflective optical elements, especially as used in optical systems for use with EUV wavelengths of light and in other optical systems used with intensities of radiation that can cause disadvantageous rates of heating of the elements.

### SUMMARY

The need expressed above is met by various aspects of the invention disclosed herein.

According to a first aspect, thermal-transfer devices are provided for an optical element that has an obverse face and a reverse face. An embodiment of such a device comprises a thermally conductive substrate having a surface. At least one mounting element extends from the surface to the reverse face of the optical element. The mounting element positions the optical element relative to the substrate with a gap between the surface and the reverse face. At least one gas-introduction port is situated relative to the gap. The device includes a gaseous thermal-conduction pathway across the gap between the optical element and the substrate. The thermal-conduction pathway comprises flowing gas introduced into the gap by the gas-introduction port.

The at least one mounting element can comprise at least one flexure allowing movement of the optical element relative to the substrate. The flexure can allow movement in one or multiple degrees of freedom. If multiple flexures are used (e.g., three flexures), they can provide movement in respective, but different, respective degree(s) of freedom.

The device further can comprise a proximity seal between the reverse face of the optical element and the surface of the substrate. The proximity seal can comprise an exit pathway for the flowing gas from the gap. In some embodiments the proximity seal extends substantially around the optical element. The proximity seal can define a second gap that is no wider than the gap between the surface and the reverse face. This second gap can serve as an escape pathway for at least some of the gas from the thermal-conduction pathway.

In certain embodiments the substrate defines a recess that opens toward the reverse face of the optical element and defines at least a portion of the gap. In this configuration the surface of the substrate is a bottom surface of the recess. The recess can be bounded by a land that defines a proximity seal between the surface and the reverse face.

The device further can comprise a temperature-controller coupled to the substrate. An exemplary temperature controller is a source of temperature-controlled fluid that is circulated relative to the substrate, such as through a fluid conduit in or in thermal contact with the substrate.

According to another aspect, cooling devices are provided for removing heat from an optical element. An embodiment of such a device comprises a thermally conductive substrate having a surface situated relative to, but separated by a gap from, a face of the optical element. At least one gas-introduction port is situated relative to the gap. A gaseous thermal-conduction pathway extends across the gap from the optical element to the substrate. The thermal-conduction pathway comprises flowing gas introduced into the gap by the gas-introduction port. The device also includes a heat-sink thermally coupled to the substrate.

The heat-sink can comprise an active-cooling device. The active-cooling device can comprise a fluid conduit associated with the substrate and a temperature-controlled fluid passing through the conduit. The fluid conduit can be configured for at least one of series and parallel flow of the coolant fluid through the conduit. The conduit can be configured so that the surface of the substrate has a controlled, substantially uniform temperature distribution or alternatively a non-uniform temperature distribution.

The optical element can be a reflective optical element, such as a mirror, having a reflective surface and a reverse surface, wherein the reverse surface faces the gap. An example reflective optical element is a mirror used for reflecting extreme UV light. Thus, the cooling device can be used for minimizing thermal distortion of the mirror and thus minimizing degradation of optical performance of the mirror.

The cooling device further can comprise a mounting device that extends across the gap and couples the surface of the optical element to the surface of the substrate. The mounting device can allow at least one respective degree of freedom of motion of the optical element relative to the substrate.

According to yet another aspect, devices are provided for reflecting light. An embodiment of such a device comprises a reflective optical element having an obverse face and a reverse face. The embodiment also includes a cooling device situated relative to the reflective optical element. The cooling device comprises: (a) a thermally conductive substrate having a surface situated relative to, but separated by a gap from, the reverse surface, (b) at least one gas-introduction port situated relative to the gap, (c) a gaseous thermal-conduction pathway extending across the gap from the optical element to the substrate, wherein the thermal-conduction pathway comprises flowing gas introduced into the gap by the gas-introduction port, and (d) a heat-sink device thermally coupled to the substrate. The device further can comprise a mounting extending across the gap and coupling the reverse face of the reflective optical element to the surface of the substrate. The mounting can include at least one flexure. An exemplary reflective optical element is an EUV-reflective mirror.

The heat-sink device can comprise a fluid conduit associated with the substrate and a temperature-controlled fluid passing through the conduit.

According to another aspect, optical systems are provided. An embodiment of such a system comprises at least one reflective optical element having an obverse face and a reverse face. A cooling device is situated relative to the reflective optical element. The cooling device comprises: (a) a thermally conductive substrate having a surface situated relative to, but separated by a gap from, the reverse surface, (b) at least one gas-introduction port situated relative to the gap, (c) a gaseous thermal-conduction pathway extending across the gap from the optical element to the substrate, wherein the thermal-conduction pathway comprises flowing gas introduced into the gap by the gas-introduction port, and (d) a heat-sink device thermally coupled to the substrate.

The optical system further can comprise a vacuum chamber enclosing the at least one reflective optical element and at least a portion of the cooling device.

According to yet another aspect, methods are provided for removing heat from an optical element having an obverse face and a reverse face. An embodiment of such a method comprises positioning a heat sink adjacent the reverse face of the optical element to form a gap between the reverse face and a surface of the heat sink. A gas is flowed into the gap to contact the reverse face of the optical element and the surface of the heat sink to provide a thermal-conduction pathway from the optical element, across the gap, to the heat sink. Using the thermal-conduction pathway, heat is conducted from the optical element to remove heat from the optical element.

The method further can comprise actively cooling the heat sink. The method further can comprise forming a proximity seal around a periphery of the optical element to enclose the thermal-conduction pathway to the gap adjacent the reverse face, and flowing at least a portion of the gas from the gap through the proximity seal to exit the gap.

The foregoing and additional features and advantages of the invention will be more readily apparent from the following detailed description, which proceeds with reference to the accompanying drawings.

### BRIEF DESCRIPTION OF THE DRAWINGS

FIGS. 1(A) and 1(B) are respective orthogonal views of a representative embodiment of a cooling device as used with a mirror as an exemplary reflective optical element.

FIGS. 2(A) and 2(B) are respective orthogonal views of an alternative embodiment of a cooling device that includes pins for supporting the central region of the mirror relative to the substrate.

FIGS. 3(A) and 3(B) are respective orthogonal views of another embodiment of a cooling device, in which the mirror is supported relative to the substrate by multiple “whiffle-tree” flexures.

FIGS. 4(A) and 4(B) are respective orthogonal views of an embodiment of a cooling device that was used for testing purposes in the Example.

FIGS. 5(A)-5(C) are respective plots of transferred power (W) as a function of gas pressure for various gases in the Example device, with a proximity-seal gap of 1 mm, 0.1 mm, and 0.01 mm, respectively.

FIG. 6 is a plot of available conditions, with respect to the Example device, of gas pressures and temperature differences that achieve 9.1 W thermal transfer, for He and N₂ and at several proximity-seal gaps of 0.01, 0.05, and 0.1 mm.

FIG. 7 is a plot, with respect to the Example device, of leakage rate (in units of Torr·L/sec), through the proximity seal and into the surrounding vacuum chamber, as a function of gas conductance (L/sec) through the proximity seal, at a gas pressure of 1000 Pascals, for He and N₂.

FIG. 8 is a plot, with respect to the Example device, of vacuum-chamber partial pressure (Torr), obtained from gas passing through the proximity seal, as a function of actual gas conductance (L/sec) through the seal, for He and N₂ at a gas pressure of 1000 Pascals.

FIG. 9 is an elevational diagram showing certain aspects of an EUVL system of which at least one mirror includes a cooling device as described herein.

FIG. 10 is a block diagram of an exemplary semiconductor-device fabrication process that includes wafer-processing steps including a lithography step.

FIG. 11 is a block diagram of a wafer-processing process as referred to in FIG. 10.

### DETAILED DESCRIPTION

This disclosure is set forth in the context of representative embodiments that are not intended to be limiting in any way.

In the following description certain words are used, such as “upward,” “downward,” “vertical,” “horizontal,” and the like. These words are used to provide clarity of the descriptions when read in the context of the drawings. Whereas these words are useful in understanding relative relationships, they are not intended to be limiting. For example, a device depicted in a drawing readily can be turned upside down, resulting in an “upper” surface becoming a “lower” surface, and vice versa.

Methods and devices as disclosed herein have utility with mirrors and other types of reflective optical elements (e.g., optical gratings and the like). Although the methods and devices are suitable for use in a vacuum environment, they are not limited to use in a vacuum environment; they can be used in atmospheric-pressure environments and in pressurized (hyper-atmospheric pressure) environments as well.

FIGS. 1(A)-1(B) depict orthogonal views of a representative embodiment of a cooling device 10 as used with a mirror 12 as an exemplary reflective optical element. The mirror 12 has a mirror body 14, a reverse face 16, and a reflective surface (obverse face) 18. The mirror 12 can be configured for any of various uses and/or optical systems. For example, the mirror 12 may be configured for use with a high-power light system, such as a high-power laser system, or with an EUV optical system. In an EUV optical system the mirror 12 can be, for example, a condensing mirror or a fly-eye mirror. Although the mirror 12 is depicted as being circular, this is not intended to be limiting in any way. The mirror 12 alternatively can have any of various other shapes such as rectilinear (e.g., square or rectangular), polygonal (e.g., hexagonal), or any other practical shape as desired or required.

The mirror body 14 is usually the residuum of the mirror blank from which the mirror 12 was fabricated. An example material for the mirror body 14 is ZERODUR® (manufactured by Schott, Germany), a glass-ceramic material that is suitable for making mirrors for EUV optical systems because of its good strength, extremely low coefficient of thermal expansion, good polishability, easy coatability, chemical stability, and non-porosity. The reflective surface (obverse face) 18 is figured (e.g., with a concave spherical or aspherical shape) for its intended use and includes an appropriate reflective layer (not detailed). For use in an EUV optical system, the reflective layer 18 typically comprises a multilayer-film coating that renders the mirror reflective to incident EUV light, as understood in the art. The mirror 12 can be configured for use in an illumination-optical system or projection-optical system of an EUV lithography system or other type of lithography system.

The reverse face 16 of the mirror 12 is coupled to a thermally conductive substrate or base 20 (generally called a “substrate” herein). For cooling purposes, the substrate 20 serves as a heat-sink for thermal energy removed from the mirror 12, as described later below. The substrate 20 can be made of any of various rigid materials, depending upon the application. For example, the substrate 20 can be a metal exhibiting high thermal conductivity and low thermal expansion. For use in EUV optical systems, a particularly advantageous material for the substrate 20 is Invar. Exemplary alternative materials include, but are not limited to, steel, aluminum, and beryllium, and any of various alloys of these. The shape of the substrate 20 usually, but not necessarily, conforms at least approximately to the shape of the mirror 12.

The substrate 20 desirably is actively cooled. In this embodiment at least one cooling-fluid passageway 22 is defined in the body 24 of the substrate 20 for conducting a coolant fluid that removes heat from the substrate 20. The main purpose of the passageway 22 is to route the coolant fluid through the body 24 in a manner that achieves a desired temperature distribution (e.g., constant-temperature profile) across the surface of the substrate 20. Hence, the passageway 22 can be used for establishing a uniform temperature throughout the substrate 20. The passageway 22 in the depicted embodiment is serpentine, but this configuration is not intended to be limiting in any way. Depending upon the application and prevailing conditions, the passageway 22 can be configured to provide series flow (as exhibited by the serpentine conduit shown) of coolant, or parallel flow of coolant (e.g., multiple parallel channels branching from a coolant plenum), or a combination of series and parallel flow. In the case of a serpentine conduit as shown, more or fewer loops can be provided, and the flow can be co-current or counter-current. The conduit can include microchannels. The passageway can be “customized” to provide a desired pattern of coolant flow. For example, the passageway 22 can be configured to provide a uniform rate of heat removal across the entire surface of the substrate, or configured to achieve a different rate of heat removal in one region versus another region so as, for example, to achieve local cooling profiles that offset a differential rate of heating in one location of the mirror versus another. An example of the latter is a passageway 22 that concentrates cooling efficiency at the middle of the substrate 20 (to remove a greater amount of heat being concentrated in the center of the mirror 12), compared to the periphery of the substrate.

The passageway(s) 22 can be formed using any of various techniques, including (but not limited to) boring into the body 24, casting the body in a manner that includes formation of the passageway(s), and milling channels in a surface of the body followed by hermetic attachment of a cover plate to the milled surface to enclose the channels in a manner that converts the channels into conduits.

The coolant fluid can be gaseous or liquid. Example fluids are fluorocarbons such as a FREON®, water, ethylene glycol, or the like. (FREON is a registered trademark of E.I. du Pont de Nemours & Company.) Generally, the coolant should be inert to the radiation reflecting from the mirror 12 and with respect to any coating(s) on the mirror. For example, even though water is a useful coolant for some applications, a water leak into the vacuum atmosphere of an EUV optical system would not be desirable.

In the depicted embodiment the coolant fluid enters the passageway 22 via at least one input port 26. After flowing in the passageway 22, the coolant fluid exits the passageway by at least one exit port 28. The exiting fluid is usually routed to a heat-exchanger or other temperature controller (not shown, but well understood in the art) that removes excess heat from the fluid passing through the exit port 28, filters and/or purifies the fluid as required, circulates the fluid, and returns the fluid to the passageway 22 via the input port 26.

In this embodiment the “upper” surface (in the figure) of the substrate 20 defines a land 34 surrounding a recess 32. Whenever the mirror 12 is placed on the substrate 20, a gap G₁ is defined between the reverse face 16 of the mirror and the surface 33 of the substrate 20. The gap G₁ is usually substantially thinner than the thickness of the mirror 12. In this embodiment the recess 32 (and thus the gap G₁) extends over almost all the reverse face 16 of the mirror 12, but does not extend over the peripheral regions of the mirror. But, such extension may not always be desirable or required in some applications. Also, whereas the recess 32 in many instances has a plan profile similar to that of the mirror 12, in some instances this may not be required or desirable.

The peripheral regions of the mirror 12 are situated adjacent the land 34; thus, the land extends around the peripheral regions of the mirror. If desired or required, one or more pins or fingers (not shown, but discussed later below in another embodiment) can be provided extending upward from selected locations on the surface 33 and contacting respective locations on the reverse face 16 of the mirror 12 to support portions of the mirror other than the peripheral regions. The pin(s) can be useful for preventing gravitational sag of the mirror 12 if the mirror has a large cross-dimension or is unusually thin.

In the depicted configuration, the mirror 12 is coupled to multiple (three are shown) flexures 36 that desirably are arranged at equally spaced positions on respective radius lines r. Ideally, the flexures 36 are located at a radius that maximizes dynamic vibration-mode frequencies of the mirror 12 and substrate 20.

In this embodiment the flexures 36 are in respective recesses 35 extending depthwise into the substrate 20 from the surface 33. The flexures 36 extend upward to the reverse face 16 of the mirror 12. The recesses 35 provide sufficient vertical space to accommodate the respective flexures without having to increase the thickness of the gap G₁. The flexures 36 have respective upper surfaces 38 that desirably are slightly higher in elevation than the land 34, which defines a gap G₂ between the mirror 12 and land 34. In this embodiment the gap G₂ forms a peripheral “proximity” (non-contacting) seal between peripheral regions of the mirror 12 and the land 34. Thus, the mirror 12 does not actually contact the land 34 or any other part of the substrate 20. The flexures 36 can be adjustable lengthwise to achieve a particular gap G₂.

In the depicted embodiment, G₁>G₂. In alternative embodiments the recess 32 is absent, so G₁=G₂. But, there is always a gap G₁ between the optical element 12 and the substrate 20.

Ideally, each flexure 36 constrains respective two degrees of freedom, so that three flexures constrain the six degrees of freedom of the mirror 12 without introducing mirror-deforming forces or moments. In this embodiment, the three flexures 36 provide a kinematic mounting for the mirror 12. A perfectly kinematic mounting is not always required. In some cases a simple three-point connection between the mirror 12 and substrate 20 would be adequate. Further alternatively, three radial flexures could be used to accommodate differential thermal expansion.

The flexures 36 can be made of any of various materials compatible with their environment. A particularly desirable material, especially if the substrate 20 is made of the same material, is Invar. Desirably, whichever material is used has a high modulus of elasticity and a low thermal-expansion coefficient. The flexures 36 can be similar or different (or two of the three can be similar), as long as the flexures collectively constrain the desired (e.g., six) degrees of freedom of the mirror 12.

If necessary, the flexures 36 can be coupled to the substrate 20 (in the depicted embodiment the bottoms of the recesses 35) and to the reverse face 16 of the mirror 12 by any of various mechanical fasteners, by any of various adhesives, or by any of various brazing, fusing, or other bonding techniques, depending upon the size, shape, and mass of the mirror and on factors such as orientation of the mirror during use and the intended use environment of the resulting assembly. The substrate 20 could be molded or formed with integral flexures, which eliminates having to fasten or otherwise couple the flexures to the substrate.

In alternative embodiments the flexures 36 can be replaced by any of various other kinematic mounts, such as ball-V-groove, three-V, and other mounts. Flexures are generally accepted for kinematic mounting of optical elements.

The flow rate of the coolant in the passageway(s) 22 desirably is controlled. For example, flow rate through, and dimensions of, the passageway(s) 22 can be selected to reduce or avoid turbulence in the coolant fluid flowing in the passageways. Turbulent flow often causes vibrations that could be transmitted to the mirror 12. Hence, the flow of coolant fluid desirably is substantially laminar, despite the more efficient thermal transfer usually achieved by turbulent flow of coolant fluid.

As the substrate 20 is being cooled by circulating fluid or otherwise, heat transfers from the mirror 12 to the substrate by conduction through the layer of flowing gas introduced into the gap G₁. As noted, the gap G₁ is thin, typically substantially less than the thickness of the mirror 12, and is sufficient for achieving desired heat transfer by the gas from the mirror to the substrate. Since the mirror 12 does not actually contact the substrate 20, heat in the mirror is conducted across the gap G₁ by the flowing gas to the substrate 20 (the substrate, in turn, acts as a heat sink). The gas enters via a conduit 40 opening into the recess 32 as one or more inlet ports 42. The inlet port 42 in this embodiment is centrally located in the recess 32 so that, as the gas enters the recess 32 via the inlet port, the gas-flow radiates outward and flows in substantially equal path lengths toward the proximity-seal gap G₂. The gap G₁ desirably is sufficiently thin or narrow to provide adequate thermal transfer between the mirror 12 and substrate 20 even with gas pressures that are substantially less than atmospheric. Avoiding mirror distortion is important with a mirror 12, such as an EUV mirror, used in a vacuum environment, wherein gas at a pressure of, e.g., one atmosphere likely would exert sufficient pressure on the mirror to cause mirror distortion. This is one reason for flowing the coolant fluid through the substrate 20 rather than through the mirror 12.

Discharge of the gas into the surrounding environment (e.g., vacuum environment) is limited by the height and width of the proximity-seal gap G₂. As noted above, the mirror 12 and substrate 20 desirably do not contact at the land 34 (the gap G₂ usually is a few micrometers at most), which avoids significant distortion of the mirror if the temperature changes. The gap G₂ also limits the leak rate of gas into the surrounding environment, particularly if the surrounding environment is a “vacuum.”

The land 34 in this embodiment is planar, and the resulting smooth proximity seal G₂ is adequate for many applications. If the leak rate of gas escaping through the proximity seal into the surrounding environment must be lower than achievable by the proximity seal, the land 34 can include at least one gas-scavenging groove (not shown) connected to a vacuum pump or the like.

In the FIG. 1(A) embodiment the flexures 36 are located near the peripheral edge of the mirror 12. In alternative embodiments the flexures can be located in a more in-board manner, closer to the center of the mirror 12. Although FIG. 1(A) depicts one respective flexure 36 on each of the respective radial lines r, in alternative embodiments more than one flexure can be located on each of the radial lines r. Multiple flexures on a radial line r can have similar or different configurations, and can have similar or different respective degree(s) of freedom.

An alternative embodiment, depicted in FIGS. 2(A)-2(B), is similar in many respects to the embodiment of FIGS. 1(A)-1(B), except that the alternative embodiment includes one or more pins 50 (three are shown) that support relatively central regions of the mirror 12 relative to the substrate 20, and thus prevent gravitational sag of the mirror 12. Each pin 50 extends “upward” across the gap G₁ from the surface 33 of the recess 32 to a respective location on the reverse face 16 of the mirror 12. In this regard, if the reverse face 16 is planar, the pins 50 can have the same “height” as the flexures 36. The pins 50 can be substantially rigid or flexible (e.g., higher stiffness in the “vertical” direction but lower stiffness in one or more lateral directions), as required or desired. Use of pins 50 may result in the mirror not being kinematically mounted, which could render the mirror more subject to distortion. Nevertheless, whereas this configuration may not be optimal for certain mirrors used in EUV lithography systems, it may be suitable for other applications, especially if the mirror is particularly large. An example of such an application is terrestrial and space-based astronomical telescopes.

Another embodiment 100, shown in FIGS. 3(A)-3(B), is similar in some respects to the embodiment of FIGS. 1(A)-1(B), except that the mirror 112 is supported relative to the substrate 114 by three “whiffle-tree” flexures 116 spaced equidistantly and equi-angularly from each other. The particular configuration of flexures shown is an example of various types of these particular flexures. Each whiffle-tree flexure 116 in this embodiment comprises a “horizontal” member 118 and a central flexure 120 extending from the middle of the horizontal member to the substrate 114. The horizontal member 118 has first and second ends including respective contact pads 122, 124 that contact the reverse face 126 of the mirror 112. Therefore, each whiffle-tree flexure 116 contacts the reverse face 126 of the mirror at two respective points. Since the two points define a respective line (oriented in this embodiment at a right angle to the respective radial line r), the mirror 112 is not over-constrained mechanically, at least for some applications.

FIG. 3(A) also depicts one manner in which parallel flow of coolant fluid can be achieved. Multiple parallel channels 128 are defined in the substrate 114. The channels 128 are connected to an input manifold 130 that is supplied by fluid via an inlet port 132 connected to the input manifold. The channels 128 are also connected to an output manifold 134 connected to an outlet port 136. Coolant fluid exits the substrate 114 via the outlet port 136 to a temperature-regulated fluid circulator (not shown).

In the embodiments described above, the recess (if provided) is defined in the surface of the substrate. In alternative embodiments the recess can be defined in the reverse face of the optical element (which places the land on the reverse face also, surrounding the recess), or partially in the surface of the substrate and partially in the reverse face of the optical element.

In the embodiments described above, the substrate is used for removing heat from (i.e., “cooling”) the mirror. However, in other embodiments intended for specialized applications, it is contemplated that the substrate can be used to add heat to the mirror across the gas layer, or at least to regulate the temperature of the mirror (which may involve either heating or cooling the mirror as conditions dictate).

In the embodiments described above, the flexures were described as at least “contacting” the reverse face of the optical element and the surface of the substrate. This “contacting” can involve simple placement of the optical element on the flexures (especially if the optical element is to be used with its reflecting, or obverse, face having an upward orientation). Alternatively, especially if the mirror is used in an orientation that is not upward-facing, it is desirable (if not outright necessary) to “couple” the flexures to the substrate and optical element in a more inalterable manner.

In the embodiments described above, the gas was introduced into the gap G₁ by one input port. In alternative embodiments, the gas is introduced via multiple input ports. The input port(s) need not have a round transverse profile.

### Study Example

An example, in the context of meeting requirements for a mirror used in an EUV optical system, was evaluated to investigate heat-conduction from a mirror, via a low-pressure gas to a heat sink (substrate). In this study, the determined power input to the mirror was 9.1 W, which was the target power that should be removed from the mirror to prevent heating of the mirror. The area of an actual mirror was 0.028 m², which was approximated using a circular plate having a diameter sufficient to provide such an area. Thus, a plate having a diameter of 189 mm was used. Gas type and pressure and other variables were adjusted to find combinations capable of producing a net heat transfer of 9.1 W, while also satisfying other criteria.

A diagram of the study apparatus 200 is shown in FIGS. 4(A)-4(B), showing the plate 210 situated relative to a substrate 212. Both the obverse and reverse faces of the plate in this example are planar and are parallel to each other. Extending into the substrate 212 are parallel conduits 214 for conducting coolant fluid used for maintaining a constant temperature of the substrate. The substrate 212 includes a circumferential land 216 surrounding a recess 218 having a “bottom” surface 220. Coupled to and extending upward from the surface 220 is an array of pins 222 that help support the plate 210. The height of the pins 222 produces a desired “G₂” gap (several gap heights were studied) in the proximity seal 224 between the land 216 and the peripheral regions of the plate 210. A gas, selected from several study gases, for conducting heat from the plate 210 to the substrate 212 is introduced into the recess 218 via an input port 226. The port 226 opens into a circular channel 228 surrounding the recess 218. Input pressure of the gas was as measured in the channel 228. Gas exited the recess 218 via the proximity seal 224.

In a first study, the total heat (power, in units of Watts) transferred from the plate 210 to the cooled substrate 212 was investigated for different gases (Ar, N₂, He, Ra) at a range of pressure (starting at 10⁵ and dropping to 10 Pascals) for several proximity-seal gaps ranging from 1 mm down to 0.01 mm. The maintained difference between the substrate 212 temperature and the mean temperature at the base surface 232 of the plate 210 was 1° C.

A plot of transferred power versus pressure for a G₂ gap of 1 mm is shown in FIG. 5(A), in which He had the greatest thermal conduction at pressures ranging from 100 to 10⁵ Pascals. For example, at 10⁵ Pascals, He transferred 4.3 W, compared to no greater than 0.7 W transferred by the other three gases. Thermal conduction declined with declining gas pressure, and at 10 Pascals all four gases exhibited nearly zero conduction. A plot of transferred power versus pressure for a G₂ gap of 0.1 mm is shown in FIG. 5(B). Again, He exhibited the greatest thermal conduction, particularly at 10³ to 10⁵ Pascals of gas pressure. For example, at 10⁵ Pascals, He transferred 43 W, compared to no greater than 7 W transferred by the other three gases. Comparing FIG. 5(B) with FIG. 5(A), reducing the proximity-seal gap by a factor of ten produced an approximately 10-fold greater thermal conduction by the gases. A plot of transferred power versus pressure for a G₂ gap of 0.01 mm is shown in FIG. 5(C), in which the ordinate (power) is logarithmic instead of linear as in FIGS. 5(A)-5(B). Again, in FIG. 5(C), He exhibited the greatest thermal conduction in the pressure range of 10² to 10⁵ Pascals. For example, at 10⁵ Pascals, He transferred approximately 200 W, compared to no greater than about 90 W transferred by the other three gases. Comparing FIG. 5(C) to FIG. 5(B), further reducing the proximity-seal gap by a factor of ten produced a correspondingly greater thermal conduction by the gases. From the results shown in FIGS. 5(A)-5(C), a smaller proximity-seal gap tends to increase the thermal conduction of any of the gases within the same range of pressures, with He exhibiting the most efficient thermal transfer of all the gases that were investigated. In FIGS. 5(A) and 5(B), the heat transfer associated with thermal radiation is shown for comparison.

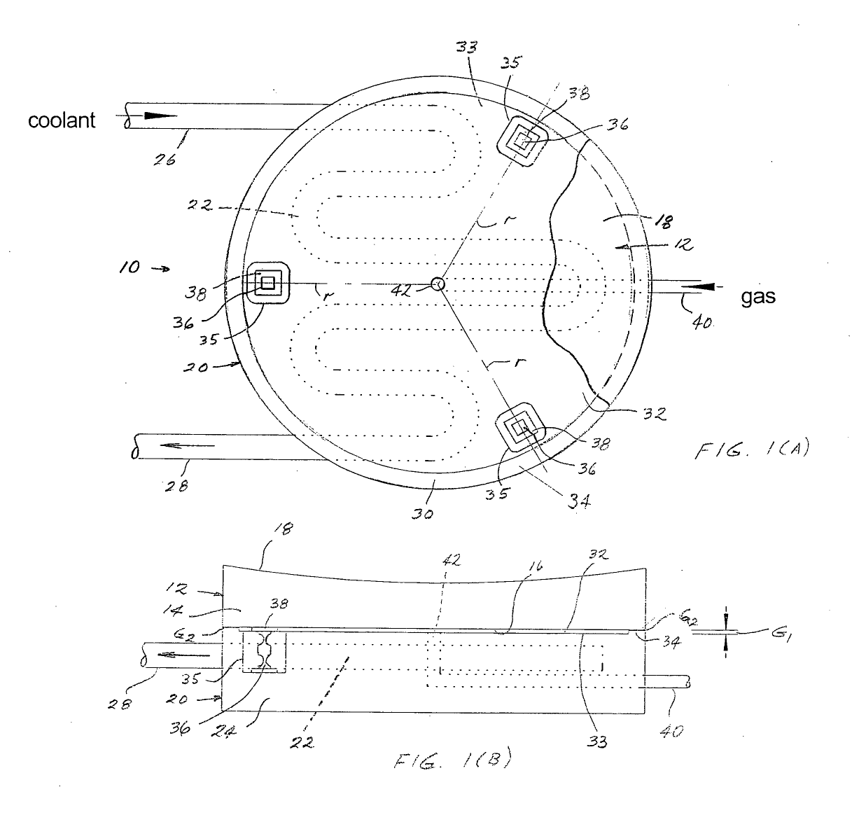

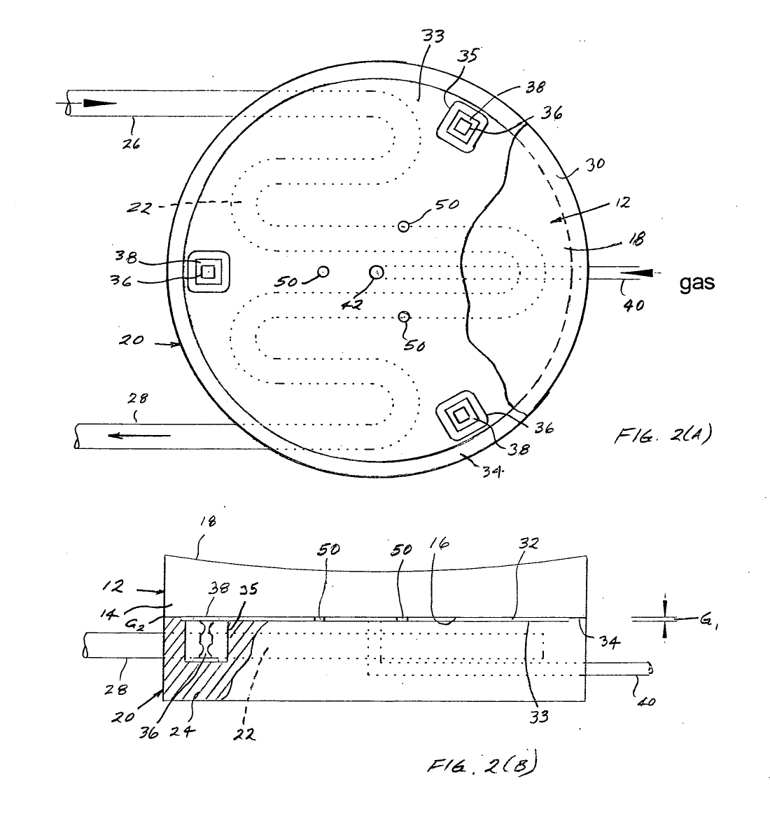

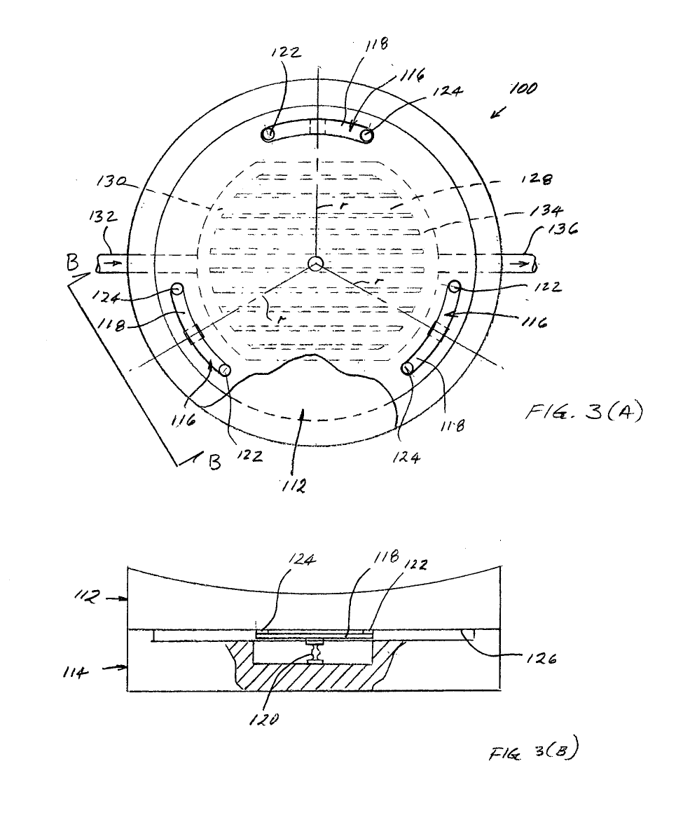

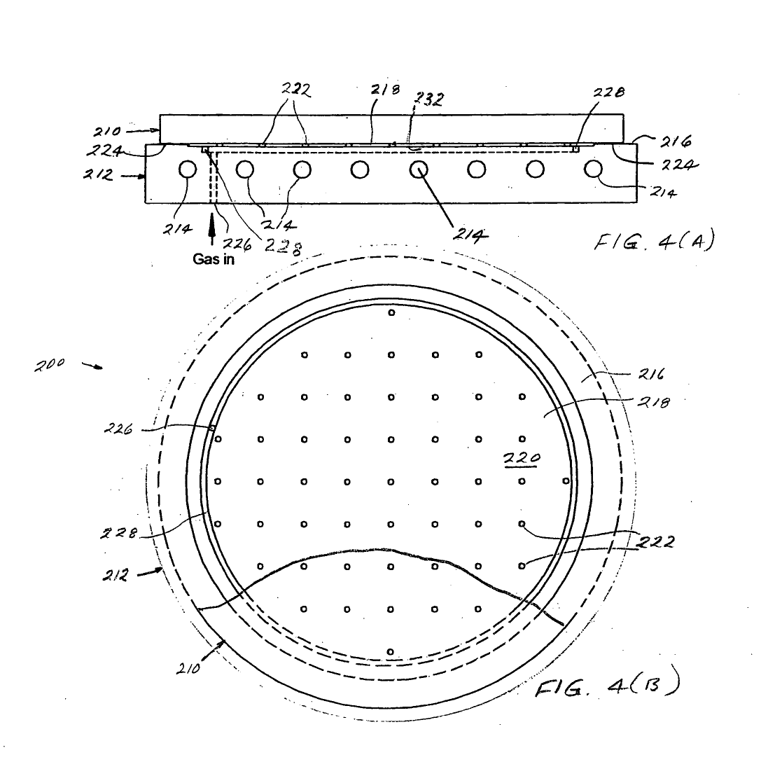

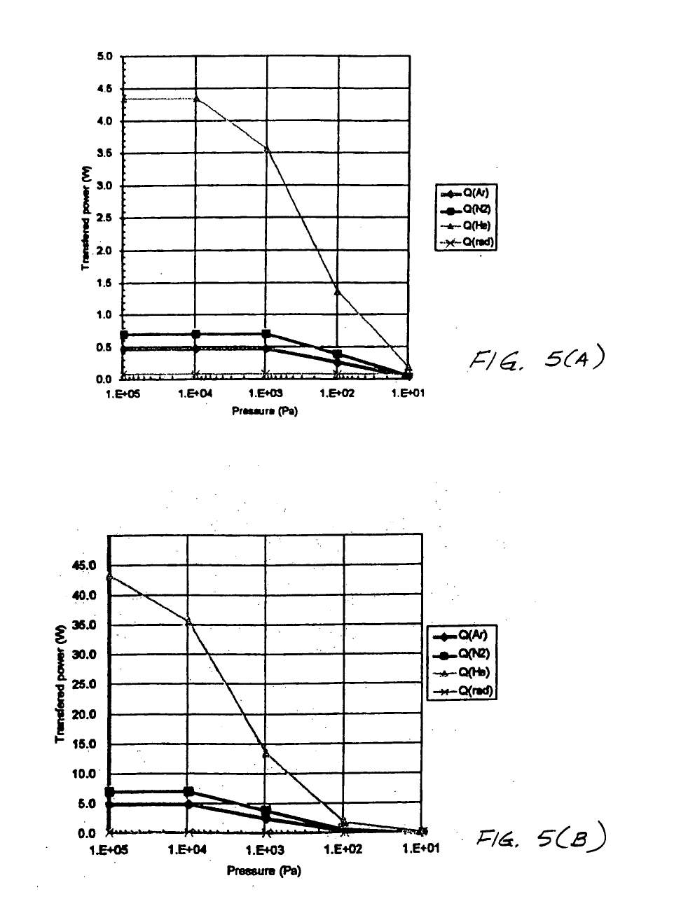

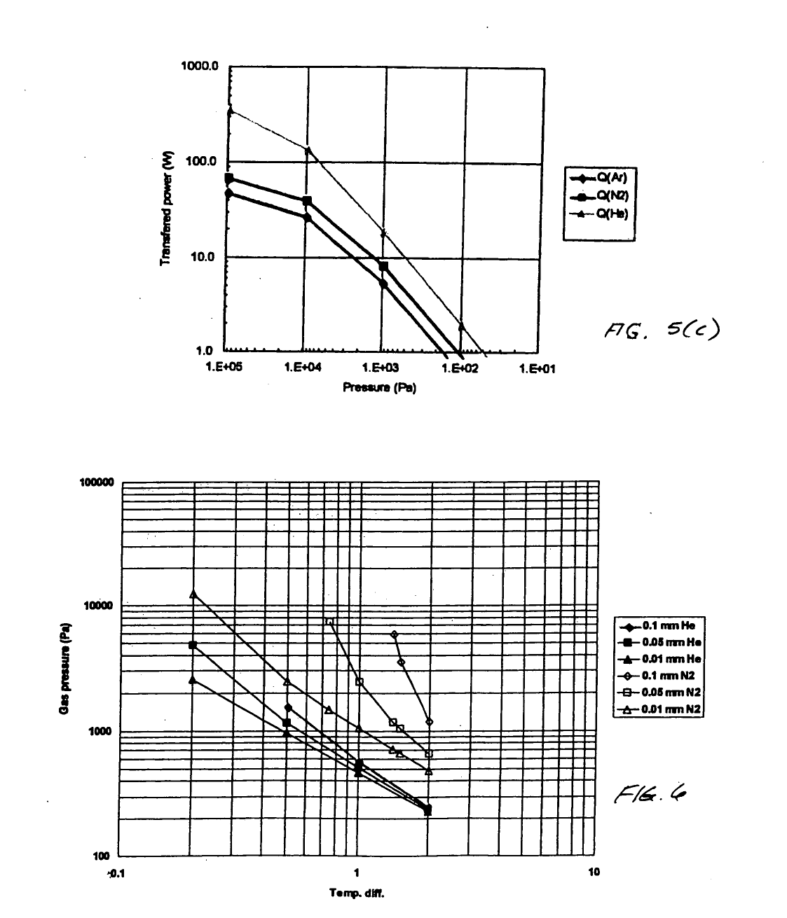

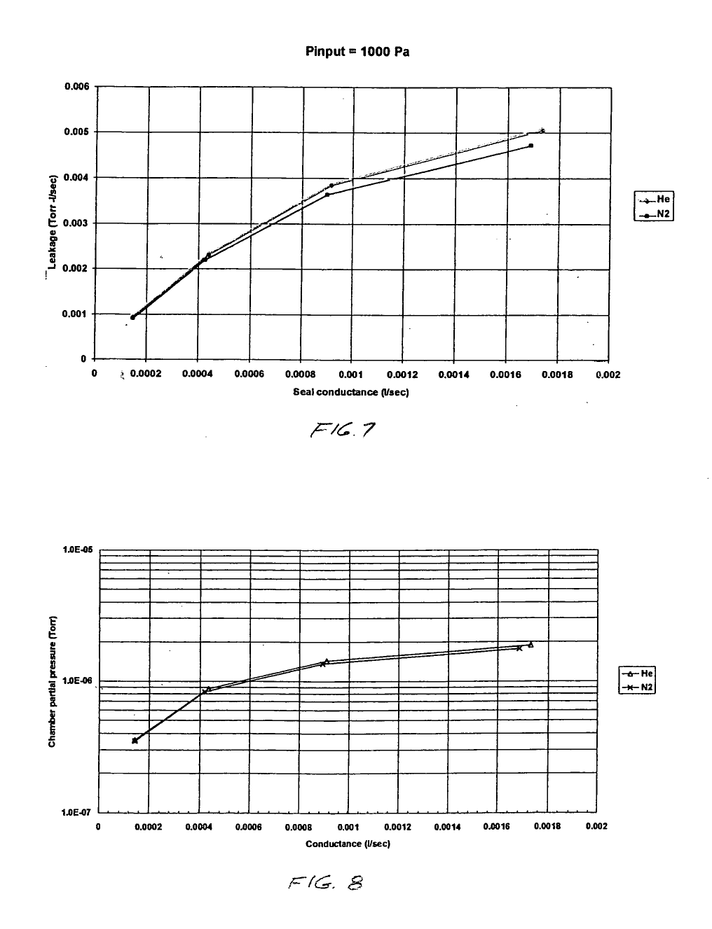

A plot of available conditions of gas pressures and temperature differences that achieve 9.1 W thermal transfer, for He and N₂ and at several proximity-seal “G₂” gaps, is shown in FIG. 6. The evaluated G₂ gaps were 0.01, 0.05, and 0.1 mm. The ordinate is logarithmic, wherein the maximum of 100,000 Pascals represents one atm pressure. The abscissa is also logarithmic. Note that all the plotted points represent respective achievements of 9.1 W thermal transfer. Note also that pressures ranging from approximately 100 to 1000 Pascals are within an acceptable range for use of the device in a “vacuum” environment such as found in an EUV optical system. At these pressures, pressure distortion of the plate 210 (i.e., of a mirror) is unlikely because these pressures are actually very low. The data in FIG. 6 showed that pressures of about 1000 Pascals for He and several thousand Pascals for N₂ appear to provide good thermal transfer (data obtained at 1000 Pascals are shown in FIGS. 7 and 8, discussed below). Radiative heat transfer from the plate 210 to the substrate 212 appears to be relatively negligible.

A non-contacting proximity seal 224 can raise certain vacuum considerations. If the G₂ gap is zero (representing a hermetic seal of the periphery of the plate 210 to the land 216), no vacuum concerns are posed. An actual gap, on the other hand, provides a route for gas escape from the recess 218 or gap G₁ to the surrounding vacuum environment. Gas flow (“leakage”) through the gap can result in some minor distortion of the mirror and can be a source of hydrocarbon or water contamination of the vacuum environment outside the recess 218. Whether the leak rates across the G₂ gap are acceptable or not depends upon system specifications and the pumping capacity of the pump used to produce and maintain the external vacuum environment. In any event, the vacuum concerns can be addressed by configuring the flexures or pins, and gas-flow rate and pressure, appropriately for establishing a desired proximity-seal gap and for preventing mirror distortion (e.g., gravitational sag). Also, appropriate attention can be given to the type and purity of the gas used for thermal transfer. Furthermore, as noted above, the land 216 can be provided with a gas-scavenging channel connected to its own vacuum pump, so as to remove gas escaping through the proximity seal before the gas escapes into the surrounding vacuum environment.

FIG. 7 is a plot of leakage rate (in units of Torr·L/sec), through the proximity seal, into the surrounding vacuum chamber as a function of gas conductance (L/sec) through the proximity seal, at a gas pressure of 1000 Pascals, for He and N₂. The resulting curves are quite similar. The left-most points of each curve represent data corresponding to a G₁ gap (of the recess 218) of 10 microns, a land width (as covered by the periphery of the plate 210) of 5 mm, and a G₂ gap (of the proximity seal 224) of 2 microns. The right-most points of each curve represent data corresponding to a G₁ gap of 10 microns, a land width of 10 mm, and a G₂ gap of 10 microns. These data reveal that gas conductance through the proximity-seal gap can be manipulated by adjustments of any of several variables (e.g., G₂ gap, land width), with similar results.

FIG. 8 is a plot of vacuum-chamber partial pressure (Torr), obtained from gas passing through the proximity seal 224, as a function of actual gas conductance (L/sec) through the seal, for He and N₂ at a gas pressure of 1000 Pascals. In this study, total vacuum-pump speed was assumed to be 2710 L/sec for N₂ (turbo-molecular pump speed is lower for He than for N₂). Note that the ordinate is logarithmic and the abscissa is linear. These data indicate that, at vacuum-pump rates normally used in EUV optical systems, the chamber partial pressure remains remarkably unchanged for a wide range of gas-leakage rates across the proximity-seal gap.

### EUVL Systems

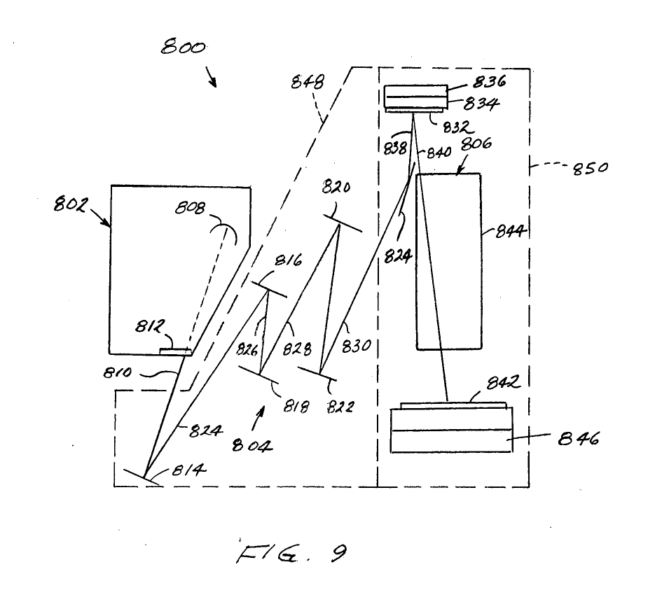

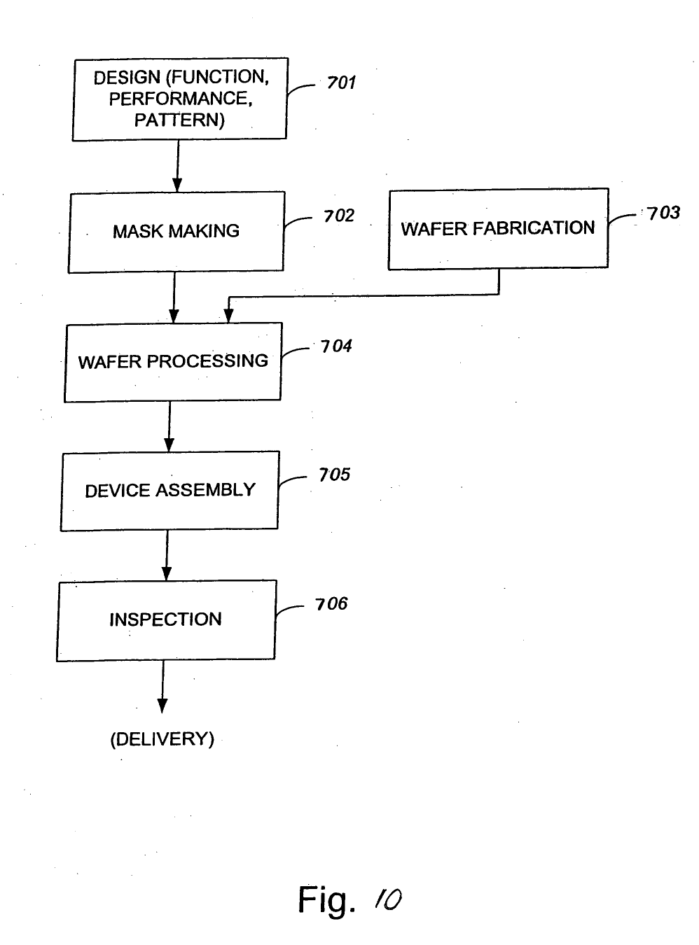

Certain aspects of a conventional EUVL system 800 are shown in FIG. 9. The depicted system includes an EUV source 802, an illumination-optical system 804, and a projection-optical system 806. The EUV source 802 produces pulses of EUV light from, for example, a laser-induced plasma or electrical-discharge-induced plasma. EUV light from the plasma is gathered by a collector mirror 808 and passed through a filter 812 to the illumination-optical system 804 (beam 810).

The depicted illumination-optical system 804 includes a collimator mirror 814, a first fly-eye mirror 816, a second fly-eye mirror 818, a first condenser mirror 820, a second condenser mirror 822, and a grazing-incidence mirror 824. These mirrors are mounted at respective locations on a rigid frame (not detailed) so as to place the mirrors in proper respective positions relative to each other. Also, all the mirrors of the illumination-optical system 804, except the grazing-incidence mirror 824, are contained in a respective vacuum chamber 848. The collimator mirror 814 collimates the EUV light from the source 802 as the EUV light reflects from the collimator mirror. The collimated light 824 propagates to the first fly-eye mirror 816, from which the light reflects (826) to the second fly-eye mirror 818. The fly-eye mirrors 816, 818 make the illumination intensity of the EUV light substantially uniform over the illumination field. From the second fly-eye mirror 322 the EUV light (828) assumes a gradually convergent characteristic as the EUV light propagates to and reflects from the first and second condenser mirrors 822, 824. From the second condenser mirror 824 the EUV light (830) reflects (at grazing incidence) from the grazing-incidence mirror 328 (usually a planar mirror) and propagates (beam 838) to the reticle 832 where the illumination field illuminates respective selected portions of the reticle pattern at particular instances in time. During illumination the reticle 832 is mounted (reflective-side facing downward) on a reticle chuck 834 that is mounted on a movable reticle stage 836. The reticle stage 836 positions the reticle 832 in three-dimensional space as required for illumination of the desired portions of the reticle pattern by the illumination field at respective instances in time.

The particular type of illumination-optical system 804 shown in FIG. 11 is a six-mirror system. So as to be reflective to incident EUV light at less than grazing angles of incidence, the collimator mirror 814, fly-eye mirrors 816, 818, and condenser mirrors 820, 822 have surficial multilayer-interference coatings (e.g., multiple superposed and very thin layer pairs of Mo and Si) that render the surfaces of these mirrors reflective to incident EUV light. Due to the manner in which the EUV light reflects from the grazing-incidence mirror 824 (i.e., at grazing angles of incidence), the grazing-incidence mirror need not have a multilayer coating. In the EUV source 802, the collector mirror 808 also has a multilayer-interference coating.

Because of the lack of suitable reticle-making materials exhibiting significant transparency to EUV light, the reticle 832 is a reflective reticle. EUV light from the grazing-incidence mirror 824 is incident on the reticle 832 at a small angle of incidence (approximately 5 degrees). So as to be reflective to EUV light at such a small angle of incidence, the reticle 832 also has a multilayer-interference coating as well as EUV-absorbent bodies that define, along with spaces between the bodies, the particular pattern on the reticle that is to be transferred to the substrate. Thus, as the EUV light reflects from the irradiated region of the reticle 832, the EUV light is “patterned” by differential reflection of the light from the pattern defined on the reticle. The patterned beam 840 acquires an aerial image of the pattern on the reticle 832 and thus is rendered capable of imaging the illuminated pattern on the surface of the resist-coated substrate 842.

To form the image on the surface of the substrate 842, the “patterned” EUV light 840 reflected from the reticle 832 passes through the projection-optical system 806, which also contains multiple reflective mirrors (not detailed, but typically four or six), to the resist-coated substrate (wafer) 842. During exposure the wafer 842 is mounted (face up) to a wafer chuck that is mounted on a wafer stage 846. The projection-optical system 806, along with the reticle 832 and substrate 842 (and associated stages) are located in a vacuum chamber 850.

Any one or more of the mirrors of the EUV lithography system described above can include a cooling apparatus as described herein.

### Semiconductor-Device Fabrication

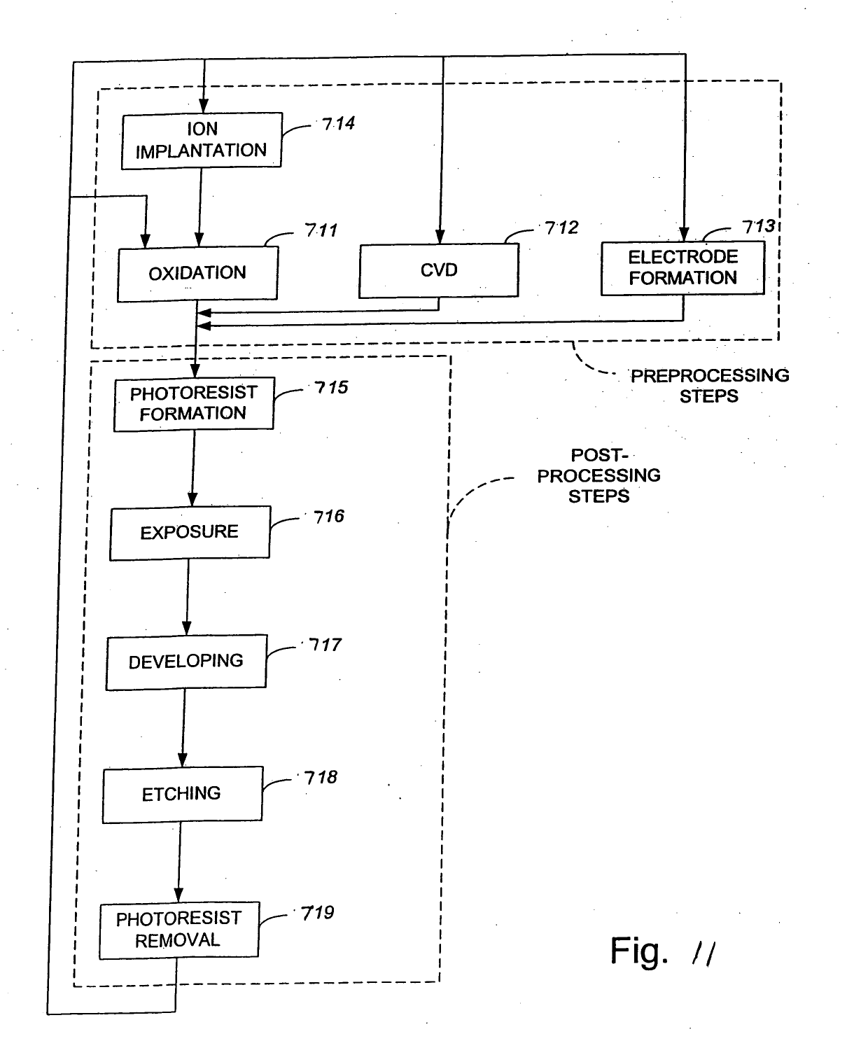

Semiconductor devices can be fabricated by processes including microlithography steps performed using a microlithography system as described above. Referring to FIG. 10, in step 701 the function and performance characteristics of the semiconductor device are designed. In step 702 a reticle defining the desired pattern is designed according to the previous design step. Meanwhile, in step 703, a substrate (wafer) is made and coated with a suitable resist. In step 704 the reticle pattern designed in step 702 is exposed onto the surface of the substrate using the microlithography system. In step 705 the semiconductor device is assembled (including “dicing” by which individual devices or “chips” are cut from the wafer, “bonding” by which wires are bonded to the particular locations on the chips, and “packaging” by which the devices are enclosed in appropriate packages for use). In step 706 the assembled devices are tested and inspected.

Representative details of a wafer-processing process including a microlithography step are shown in FIG. 11. In step 711 (oxidation) the wafer surface is oxidized. In step 712 (CVD) an insulative layer is formed on the wafer surface. In step 713 (electrode formation) electrodes are formed on the wafer surface by vapor deposition for example. In step 714 (ion implantation) ions are implanted in the wafer surface. These steps 711-714 constitute representative “pre-processing” steps for wafers, and selections are made at each step according to processing requirements.

At each stage of wafer processing, when the pre-processing steps have been completed, the following “post-processing” steps are implemented. A first post-process step is step 715 (photoresist formation) in which a suitable resist is applied to the surface of the wafer. Next, in step 716 (exposure), the microlithography system described above is used for lithographically transferring a pattern from the reticle to the resist layer on the wafer. In step 717 (development) the exposed resist on the wafer is developed to form a usable mask pattern, corresponding to the resist pattern, in the resist on the wafer. In step 718 (etching), regions not covered by developed resist (i.e., exposed material surfaces) are etched away to a controlled depth. In step 719 (photoresist removal), residual developed resist is removed (“stripped”) from the wafer.

Formation of multiple interconnected layers of circuit patterns on the wafer is achieved by repeating the pre-processing and post-processing steps as required. Generally, a set of pre-processing and post-processing steps are conducted to form each layer.

It will be apparent to persons of ordinary skill in the relevant art that various modifications and variations can be made to any of the embodiments described above without departing from the spirit and scope of this disclosure.

What is claimed is:

1. A thermal-transfer device for an optical element having an obverse face and a reverse face, the device comprising:
a thermally conductive substrate having a surface;
at least one mounting element extending from the surface to the reverse face of the optical element, the mounting element positioning the optical element relative to the substrate with a gap between the surface and the reverse face;
at least one gas-introduction port situated relative to the gap; and
a gaseous thermal-conduction pathway across the gap between the optical element and the substrate, the thermal-conduction pathway comprising flowing gas introduced into the gap by the gas-introduction port.

2. The device of claim 1, wherein the at least one mounting element comprises at least one flexure allowing movement of the optical element relative to the substrate.

3. The device of claim 1, further comprising a proximity seal between the reverse face of the optical element and the surface of the substrate.

4. The device of claim 3, wherein the proximity seal comprises an exit pathway for the flowing gas from the gap.

5. The device of claim 4, wherein the proximity seal extends substantially around the optical element.

6. The device of claim 4, wherein the proximity seal defines a second gap that is no wider than the gap between the surface and the reverse face.

7. The device of claim 1, wherein:
the substrate defines a recess that opens toward the reverse face of the optical element and defines at least a portion of the gap;
the surface of the substrate is a bottom surface of the recess; and
the recess is bounded by a land defining a proximity seal between the surface and the reverse face.

8. The device of claim 1, wherein:
the at least one mounting element comprises multiple individual mounting elements; and
each mounting element comprises a flexure having at least one respective degree of freedom of motion.

9. The device of claim 8, wherein the multiple mounting elements comprise three respective flexures each configured to permit at least one respective degree of freedom of motion of the optical element relative to the substrate.

10. The device of claim 1, further comprising a temperature-controller coupled to the substrate.

11. A cooling device for removing heat from an optical element, comprising:
a thermally conductive substrate having a surface situated relative to, but separated by a gap from, a face of the optical element;
at least one gas-introduction port situated relative to the gap;
a gaseous thermal-conduction pathway extending across the gap from the optical element to the substrate, the thermal-conduction pathway comprising flowing gas introduced into the gap by the gas-introduction port; and
a heat-sink thermally coupled to the substrate.

12. The device of claim 11, wherein the heat-sink comprises an active-cooling device.

13. The device of claim 12, wherein the active-cooling device comprises:
a fluid conduit associated with the substrate; and
a temperature-controlled fluid passing through the conduit.

14. The device of claim 11, wherein:
the optical element is a mirror having a reflective surface and a reverse surface; and
the reverse surface faces the gap.

15. The device of claim 11, further comprising a mounting device extending across the gap and coupling the surface of the optical element to the surface of the substrate.

16. A device for reflecting light, comprising:
a reflective optical element having an obverse face and a reverse face; and
a cooling device situated relative to the reflective optical element, the cooling device comprising (a) a thermally conductive substrate having a surface situated relative to, but separated by a gap from, the reverse surface; (b) at least one gas-introduction port situated relative to the gap; (c) a gaseous thermal-conduction pathway extending across the gap from the optical element to the substrate, the thermal-conduction pathway comprising flowing gas introduced into the gap by the gas-introduction port; and (d) a heat-sink device thermally coupled to the substrate.

17. The device of claim 16, further comprising a mounting extending across the gap and coupling the reverse face of the reflective optical element to the surface of the substrate.

18. The device of claim 17, wherein the mounting includes at least one flexure.

19. The device of claim 16, wherein the reflective optical element is an EUV-reflective mirror.

20. The device of claim 16, wherein the heat-sink device comprises:
a fluid conduit associated with the substrate; and
a temperature-controlled fluid passing through the conduit.

21. An optical system, comprising:
at least one reflective optical element having an obverse face and a reverse face; and
a cooling device situated relative to the reflective optical element, the cooling device comprising (a) a thermally conductive substrate having a surface situated relative to, but separated by a gap from, the reverse surface; (b) at least one gas-introduction port situated relative to the gap; (c) a gaseous thermal-conduction pathway extending across the gap from the optical element to the substrate, the thermal-conduction pathway comprising flowing gas introduced into the gap by the gas-introduction port; and (d) a heat-sink device thermally coupled to the substrate.

22. The optical system of claim 21, further comprising a vacuum chamber enclosing the at least one reflective optical element and at least a portion of the cooling device.

23. A method for removing heat from an optical element having an obverse face and a reverse face, the method comprising:
positioning a heat sink adjacent the reverse face of the optical element to form a gap between the reverse face and a surface of the heat sink;
flowing a gas into the gap to contact the reverse face of the optical element and the surface of the heat sink to provide a thermal-conduction pathway from the optical element, across the gap, to the heat sink; and
using the thermal-conduction pathway, conducting heat from the optical element to remove heat from the optical element.

24. The method of claim 23, further comprising actively cooling the heat sink.

25. The method of claim 23, further comprising:
forming a proximity seal around a periphery of the optical element to enclose the thermal-conduction pathway to the gap adjacent the reverse face; and
flowing at least a portion of the gas from the gap through the proximity seal to exit the gap.
